(19) United States
(12) Patent Application Publication
(10) Pub. No.: US 2015/0076897 A1
(43) Pub. Date: Mar. 19, 2015

(54) METHOD OF CONTROLLING A BRAKE SYSTEM

(71) Applicant: AISAN KOGYO KABUSHIKI KAISHA, Obu-shi (JP)

(72) Inventors: Minoru AKITA, Ama-shi (JP); Katsuhiko MAKINO, Chita-gun (JP); Yuzuru ITO, Chiryu-shi (JP)

(21) Appl. No.: 14/474,925

(22) Filed: Sep. 2, 2014

(30) Foreign Application Priority Data
Sep. 16, 2013 (JP) 2013-191246

(51) Int. Cl. B60T 13/72; B60T 13/16

(52) U.S. Cl. CPC B60T 13/72; B60T 13/162
USPC 303/12

(57) ABSTRACT

In a method of controlling a brake system, a basic control to operate an electric vacuum pump is performed when a booster internal pressure, i.e., an actual pressure of a negative pressure chamber of a brake booster, is larger than a target booster internal pressure, i.e., a target pressure in the negative pressure chamber. The electric vacuum pump is not operated under a predetermined condition even when the booster internal pressure is larger than the target booster internal pressure.

### CROSS-REFERENCE TO RELATED APPLICATIONS

This application is based upon and claims the benefit of priority from the prior Japanese Patent Application No. 2013-191246 filed on Sep. 16, 2013, the entire contents of which are incorporated herein by reference.

### BACKGROUND OF THE INVENTION

1. Field of the Invention

The present invention relates to a method of controlling a brake system to supply negative pressure generated in an intake system of an engine and negative pressure generated in a vacuum pump to a negative pressure chamber of a brake booster.

2. Related Art

Herein, Patent Document 1 discloses a brake system arranged to operate or activate an electric vacuum pump to supply negative pressure to a brake booster when negative pressure in the brake booster is equal to or lower than a predetermined value. In the brake system in Patent Document 1, the predetermined value to be used for a predetermined period after starting of an internal combustion engine is set low so as not to operate the electric vacuum pump.

### RELATED ART DOCUMENTS

### Patent Documents

Patent Document 1: JP-A-2006-142942

### SUMMARY OF INVENTION

### Problems to be Solved by the Invention

However, the brake system in Patent Document 1 is configured without considering reducing of the frequency (i.e., the number of times) of operating the vacuum pump even after a lapse of a predetermined time from the starting of the internal combustion engine. Thus, the frequency of operating the electric vacuum pump is increased, which may deteriorate durability of the electric vacuum pump.

The present invention has been made to solve the above problems and has a purpose to provide a method of controlling a brake system to reliably reduce the frequency of operating a vacuum pump.

### Means of Solving the Problems

To achieve the above purpose, one aspect of the invention provides a method of controlling a brake system of an engine, the brake system including a brake booster having a negative pressure chamber and a vacuum pump having an inlet connected to the negative pressure chamber, the engine having an intake system being connected to the negative pressure chamber, wherein the method includes a basic control to operate the vacuum pump when a booster internal pressure which is an actual pressure in the negative pressure chamber is larger than a target booster internal pressure which is a target pressure in the negative pressure chamber, and the vacuum pump is not operated under a predetermined condition even when the booster internal pressure is larger than the target booster internal pressure.

According to the above aspect, even when the booster internal pressure is larger than the target booster internal pressure, the vacuum pump is not operated under the predetermined condition that the vacuum pump does not have to be operated. Thus, the frequency of operating the vacuum pump is reliably reduced. This can improve the durability of the vacuum pump. In particular, as compared with the brake system in Patent Document 1, the frequency of operating the vacuum pump can be reliably reduced irrespective of a lapse of time from starting of an internal combustion engine.

In the above aspect, preferably, the predetermined condition includes a condition that an internal pressure of the intake system is equal to or lower than the target booster internal pressure.

According to the above configuration, even when the booster internal pressure is larger than the target booster internal pressure, the vacuum pump is not operated under the condition that the internal pressure of the intake system is equal to or lower than the target booster internal pressure. In this way, the booster internal pressure can be decreased to be equal to or lower than the target booster internal pressure by the internal pressure of the intake system even without operating the vacuum pump. Thus, the frequency of operating the vacuum pump is more effectively reduced.

In the above aspect, preferably, the predetermined condition includes a condition that a vehicle in which the brake system is mounted is being accelerated.

According to the above configuration, even when the booster internal pressure is larger than the target booster internal pressure, the vacuum pump is not operated under the condition that a vehicle is being accelerated. In this way, during acceleration of the vehicle where a driver is less likely to operate a brake, the vacuum pump is not operated. Thus, the frequency and time of operating the vacuum pump can be reduced more effectively.

In the above aspect, preferably, the vacuum pump is operated when a pressure difference calculated by subtracting the target booster internal pressure from the booster internal pressure is larger than a first predetermined pressure even during acceleration of the vehicle.

According to the above configuration, the vacuum pump is caused to operate in a case where the booster internal pressure may greatly rises, for example, when the vehicle is repeatedly accelerated or the vehicle is suddenly stopped from a high-speed running condition. Thus, the booster internal pressure is always maintained to be equal to or lower than the target booster internal pressure.

In the above aspect, preferably, when the booster internal pressure is bpm, the target booster internal pressure is BPM, and a second predetermined pressure is D, the vacuum pump is stopped when a conditional expression of bpm<(BPM−D) is met while the vehicle is being accelerated and the vacuum pump is being operated.

According to the above configuration, when the booster internal pressure decreases below the target booster internal pressure by an amount corresponding to the second predetermined pressure while the vacuum pump is being operated, the vacuum pump is stopped. Thus, the frequency of operating the vacuum pump is reduced as compared with a control method performed by operating a vacuum pump until a booster internal pressure decreases below a pump stop pressure set to an always fixed value.

In the above aspect, preferably, the predetermined condition includes a condition that the internal pressure of the intake system is smaller than the booster internal pressure.

According to the above configuration, even when the booster internal pressure is larger than the target booster internal pressure, the vacuum pump is not operated under the condition that the internal pressure of the intake system is smaller than the booster internal pressure. In this way, when the booster internal pressure can be reduced by a pressure difference between the internal pressure of the intake system and the booster internal pressure, the vacuum pump is not operated. Accordingly, the frequency and time of operating the vacuum pump can be reduced more effectively. In particular, while a brake pedal is depressed by a driver, the opening degree of a throttle valve is decreased, so that the internal pressure of the intake system becomes small and thus the performance of reducing the booster internal pressure can be enhanced.

### Advantageous Effects of Invention

According to a method of controlling a brake system according to the present invention, it is possible to reliably reduce the frequency of operating a vacuum pump.

### BRIEF DESCRIPTION OF THE DRAWINGS

FIG. 1 is a schematic configuration view of a brake system;

FIG. 2 is a flowchart showing a control routine of Example 1;

FIG. 3 shows one example of a time chart of Example 1;

FIG. 4 is a flowchart showing a control routine of Example 2;

FIG. 5 shows one example of a time chart of Example 2;

FIG. 6 is a flowchart showing a control routine of Example 3;

FIG. 7 is a flowchart showing a control routine of Example 4;

FIG. 8 shows one example of a time chart of Example 4;

FIG. 9 is a flowchart showing a control routine of Example 5;

FIG. 10 is a flowchart showing a control routine of Example 6;

FIG. 11 is a flowchart showing a control routine of Example 7;

FIG. 12 shows one example of a time chart of Example 7; and

FIG. 13 is a flowchart showing a control routine of Example 8.

### DESCRIPTION OF EMBODIMENTS

### Configuration of Brake System

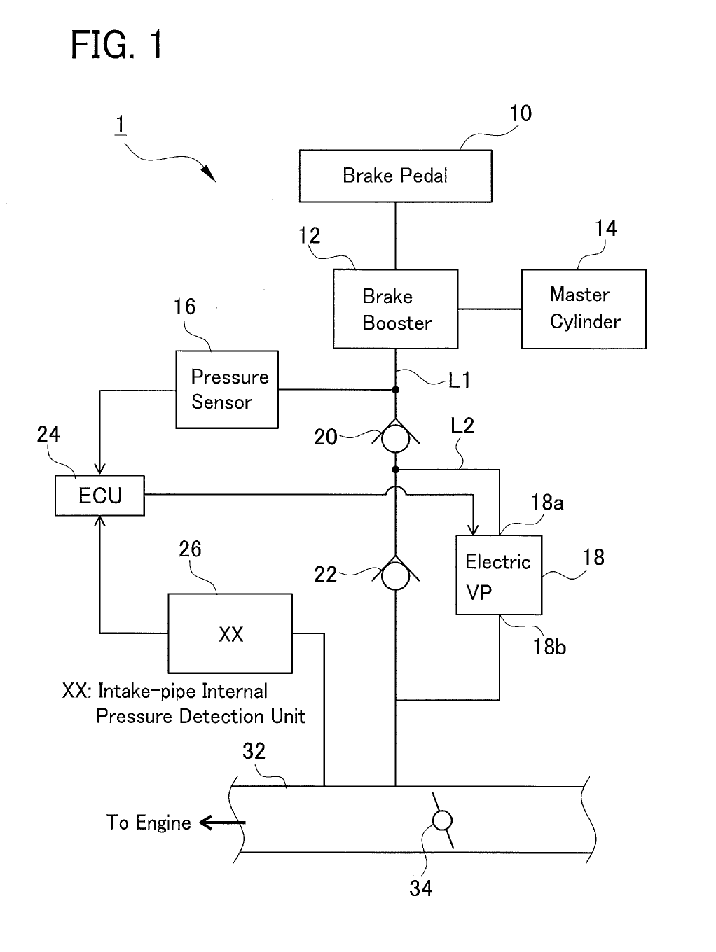

A detailed description of a preferred embodiment of a brake system embodying the present invention will now be given referring to the accompanying drawings. FIG. 1 is a schematic configuration view of the brake system. In the following explanation, a term “negative pressure” represents a pressure lower than atmospheric pressure.

A brake system 1 includes, as shown in FIG. 1, a brake pedal 10, a brake booster 12, a master cylinder 14, a pressure sensor 16, an electric vacuum pump 18 (labeled as “Electric VP” in FIG. 1), a first check valve 20, a second check valve 22, an ECU 24, a unit 26 for detecting internal pressure of an intake pipe (“intake-pipe internal-pressure detection unit”), and others.

The brake booster 12 is provided between the brake pedal 10 and the master cylinder 14 as shown in FIG. 1. This brake booster 12 can generate assist power at a predetermined boosting ratio with respect to the tread force on the brake pedal 10.

The brake booster 12 is internally partitioned by a diaphragm (not shown) into a negative pressure chamber (not shown) located close to the master cylinder 14 and a transformer chamber (not shown) allowing introduction of atmospheric air. The negative pressure chamber of the brake booster 12 is connected to an intake pipe 32 of an engine through a first passage L1. That is, the first passage L1 is connected to the negative pressure chamber of the brake booster 12 and the intake pipe 32. Accordingly, the negative pressure generated in the intake pipe 32 according to the opening degree of a throttle valve 34 during driving of the engine is supplied to the negative pressure chamber of the brake booster 12 via the first passage L1. The intake pipe 32 is one example of an “intake system” of the invention.

The master cylinder 14 increases oil pressure of a brake main body (not shown) by operation of the brake booster 12, thereby generating a braking force in the brake main body. The pressure sensor 16 detects a booster internal pressure bpm which is the actual pressure in the negative pressure chamber of the brake booster 12.

The electric vacuum pump 18 is connected to a second passage L2 as shown in FIG. 1. That is, an inlet 18a of the pump 18 is connected to the negative pressure chamber of the brake booster 12 via the second passage L2 and the first passage L1. Further, an outlet 18b of the pump 18 is connected via the second passage L2 and the first passage L1 to the intake pipe 32 at a position downstream (on a side close to the engine) of the throttle valve 34 in the intake pipe 32. Herein, the second passage L2 is a channel branching from the first passage L1 at a position on the first passage L1 between the first check valve 20 and the second check valve 22. The pump 18 is controlled by the ECU 24.

The first check valve 20 is provided in a position between the brake booster 12 and a branching point between the first passage L1 and the second passage L2. The second check valve 22 is provided in a position closer to the intake pipe 32 than the first check valve 20 in the first passage L1 and between the branching point to the second passage L2 and the intake pipe 32. The first check valve 20 and the second check valve 22 are operative to open only when the negative pressure on the side close to the intake pipe 32 is higher than the negative pressure on the side close to the negative pressure chamber of the brake booster 12, thereby permitting a fluid to flow only from the negative pressure chamber of the brake booster 12 toward the intake pipe 32. In this manner, the brake system 1 can encapsulate negative pressure in the negative pressure chamber of the brake booster 12 by the first check valve 20 and the second check valve 22.

The ECU 24 consists of for example a microcomputer and includes a ROM that stores control programs, a rewritable RAM that stores calculation results and others, a timer, a counter, an input interface, and an output interface. To this ECU 24, as shown in FIG. 1, there are connected the pressure sensor 16, the electric vacuum pump 18, the intake-pipe internal-pressure detecting unit 26, and others. The ECU 24 controls the brake system 1 (the electric vacuum pump 18) by a control method as described later.

The intake-pipe internal-pressure detection unit 26 is operative to detect an intake-pipe internal-pressure pm which is the internal pressure of the intake pipe 32. The intake-pipe internal-pressure pm is one example of an “internal pressure of an intake system” of the invention.

<Method of Controlling Brake System>

The method of controlling the brake system 1 configured as above will be explained below. This control method of the brake system 1 includes a basic control to be executed by the ECU 24 to operate the electric vacuum pump 18 when the booster internal pressure bpm is larger than a target booster internal pressure BPM. Furthermore, the following controls will be performed in various situations. The target booster internal pressure BPM is a target pressure in the negative pressure chamber of the brake booster 12. This target pressure BPM is changed according to a speed (vehicle speed) of a car in which the brake system 1 is mounted.

### Example 1

In Example 1, even when the booster internal pressure bpm is larger than the target booster internal pressure BPM, the ECU 24 controls the electric vacuum pump 18 not to operate if the intake-pipe internal pressure pm is equal to or lower than the target booster internal pressure BPM.

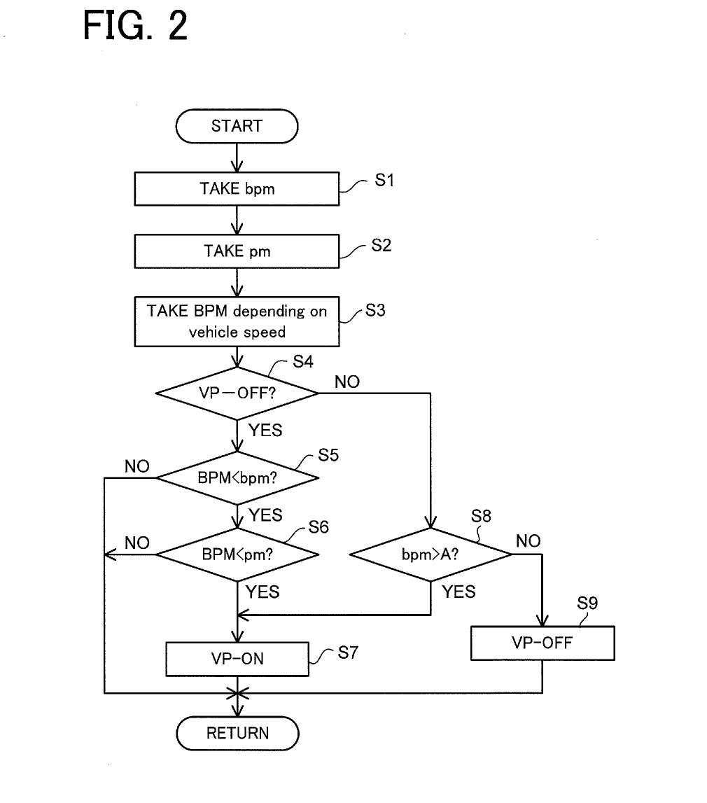

To be concrete, the ECU 24 periodically executes the control routine shown in FIG. 2 at predetermined time intervals.

When the routine processing shown in FIG. 2 is started, the ECU 24 first takes, or reads, a booster internal pressure bpm, an intake-pipe internal pressure pm, and a target booster internal pressure BPM depending on the vehicle speed (the target booster internal pressure BPM according to the vehicle speed) (steps S1 to S3). Instead of taking the intake-pipe internal pressure pm detected by the intake-pipe internal-pressure detecting unit 26, the ECU 24 may store a corresponding diagram (a map) of the intake-pipe internal pressure pm obtained in advance from engine rotation number and throttle opening degree and take the intake-pipe internal pressure pm from this corresponding diagram.

When the electric vacuum pump 18 is being stopped (an OFF state) (step S4: YES) and the booster internal pressure bpm is determined to be larger than the target booster internal pressure BPM (step S5: YES), the ECU 24 successively determines whether or not the intake-pipe internal pressure pm is larger than the target booster internal pressure BPM (step S6).

When the intake-pipe internal pressure pm is determined to be larger than the target booster internal pressure BPM (step S6: YES), the ECU 24 operates the electric vacuum pump 18 (an ON state) (step S7) and temporarily terminates the routine processing.

On the other hand, when the intake-pipe internal pressure pm is determined to be equal to or lower than the target booster internal pressure BPM (step S6: NO), the ECU 24 temporarily terminates the routine processing while keeping the electric vacuum pump 18 stopped without operating the same.

As above, even when the booster internal pressure bpm is larger than the target booster internal pressure BPM, the ECU 24 does not activate the electric vacuum pump 18 under the condition that the intake-pipe internal pressure pm is equal to or lower than the target booster internal pressure BPM. At that time, the booster internal pressure bpm is reduced to be equal to or lower than the target booster internal pressure BPM by the intake-pipe internal pressure pm. Specifically, the negative pressure of the intake pipe 32 is supplied to the negative pressure chamber of the brake booster 12.

When the ECU 24 determines in step S4 that the electric vacuum pump 18 is being operated (step S4: NO), the ECU 24 determines whether or not the booster internal pressure bpm is larger than a predetermined pressure A (step S8). This predetermined pressure A is, for example, −80 kPa in the present embodiment.

When the booster internal pressure bpm is determined to be larger than the predetermined pressure A (step S8: YES), the ECU 24 continues to operate the electric vacuum pump 18 (step S7) and temporarily terminates the routine processing.

On the other hand, when the booster internal pressure bpm is determined to be equal to or lower than the predetermined pressure A (step S8: NO), the ECU 24 stops the electric vacuum pump 18 (step S9) and temporarily terminates the routine processing. Specifically, the predetermined pressure A is a pump stop pressure which is a reference pressure used to stop the pump 18 under operation.

In this way, during operation of the pump 18, when the booster internal pressure bpm becomes equal to or lower than the predetermined pressure A, the ECU 24 stops the electric vacuum pump 18.

Furthermore, when the ECU 24 determines in step S5 that the booster internal pressure bpm is equal to or lower than the target booster internal pressure BPM (step S5: NO), the ECU 24 continues to stop the electric vacuum pump 18 and temporarily terminates the routine processing.

The above explanation is related to the control routine shown in FIG. 2.

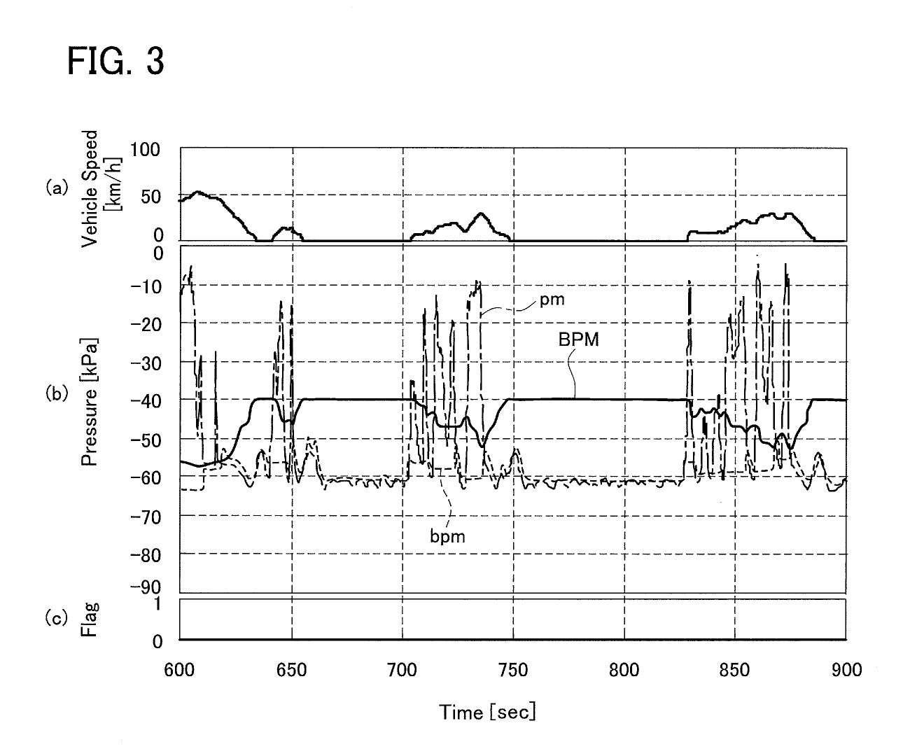

In the brake system 1, the ECU 24 periodically executes the control routine shown in FIG. 24 at the predetermined time intervals, thereby enabling for example the control shown by a time chart in FIG. 3.

As shown in FIG. 3, the booster internal pressure bpm is equal to or lower than the target booster internal pressure BPM by the intake-pipe internal pressure pm, so that the electric vacuum pump 18 is held stopped. That is, an operation flag of the electric vacuum pump 18 is “0” as shown in FIG. 3. In this way, the frequency of operating the electric vacuum pump 18 can be reliably reduced.

In the present example as explained above, the ECU 24 does not activate the electric vacuum pump 18 under the condition that the intake-pipe internal pressure pm is equal to or lower than the target booster internal pressure BPM even when the booster internal pressure bpm is larger than the target booster internal pressure BPM.

As above, even when the booster internal pressure bpm is larger than the target booster internal pressure BPM, the ECU 24 does not operate the electric vacuum pump 18 under the predetermined condition that the pump 18 does not have to be operated. Accordingly, the frequency of operating the electric vacuum pump 18 can be reliably reduced.

Even without operating the electric vacuum pump 18, the booster internal pressure bpm can be reduced to be equal to or lower than the target booster internal pressure BPM by the intake-pipe internal pressure pm. Therefore, the frequency of operating the electric vacuum pump 18 can be reduced more effectively.

### Example 2

Example 2 will be explained below, in which similar or identical parts to those in Example 1 are omitted and differences from Example 1 are mainly described. In Example 2, even when the booster internal pressure bpm is larger than the target booster internal pressure BPM, the ECU 24 does not operate the electric vacuum pump 18 during acceleration of a vehicle in which the brake system 1 is mounted.

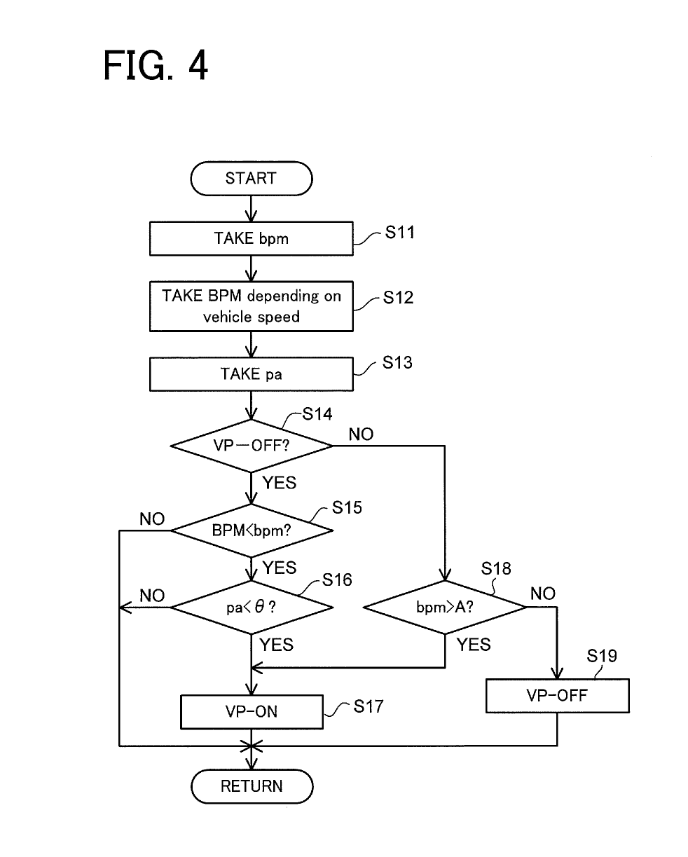

To be concrete, the ECU 24 periodically executes the control routine shown in FIG. 4 at predetermined time intervals.

When the routine processing shown in FIG. 4 is started, the ECU 24 first takes a booster internal pressure bpm, a target booster internal pressure BPM depending on vehicle speed, and an accelerator opening degree pa (steps S11 to S13). The accelerator opening degree pa represents a depression amount of an accelerator pedal (not shown) detected by an unillustrated accelerator position sensor.

When the electric vacuum pump 18 is being stopped (step S14: YES) and the booster internal pressure bpm is determined to be larger than the target booster internal pressure BPM (step S15: YES), the ECU 24 then determines whether or not the accelerator opening degree pa is smaller than a predetermined opening degree 0 (step S16). This predetermined opening degree θ is for example 3 degrees.

When the accelerator opening degree pa is determined to be smaller than the predetermined opening degree θ (step S16: YES), the ECU 24 operates the electric vacuum pump 18 (step S17) and temporarily terminates the routine processing.

On the other hand, when the accelerator opening degree pa is determined to be equal to or larger than the predetermined opening degree θ (step S16: NO), the ECU 24 temporarily terminates the routine processing while keeping the pump 18 stopped without operating the same.

As above, even when the booster internal pressure bpm is larger than the target booster internal pressure BPM, the ECU 24 does not activate the electric vacuum pump 18 under the condition that the vehicle is being accelerated by depression of the accelerator pedal by a driver with purpose.

The above explanation is related to the control routine shown in FIG. 4.

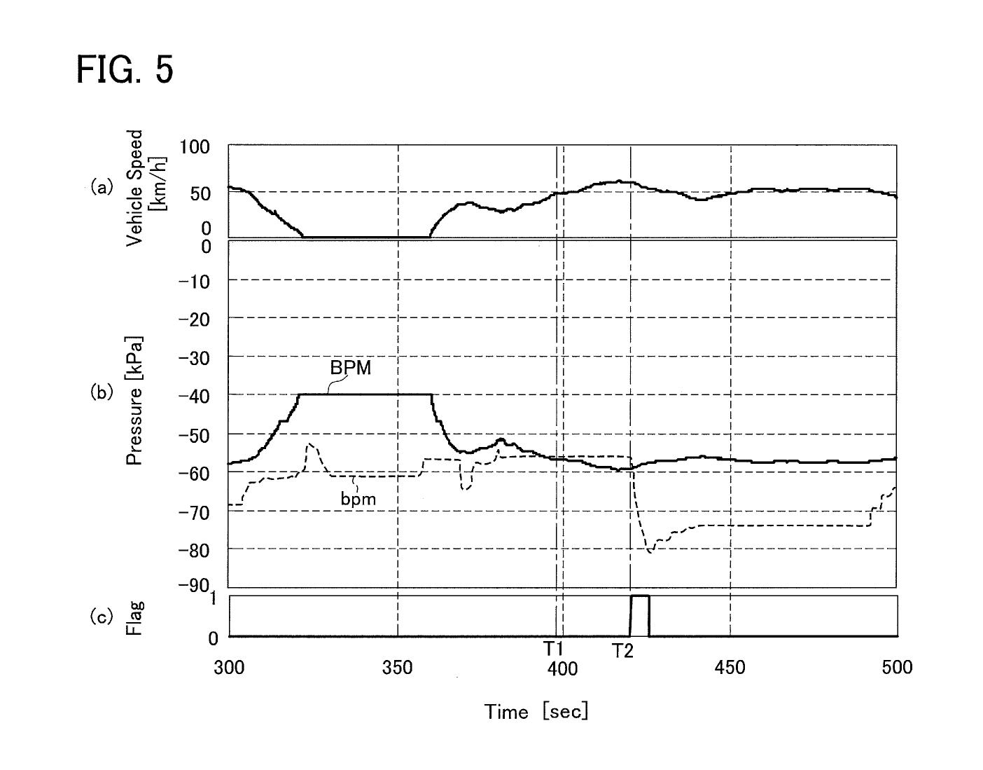

In the brake system 1, the ECU 24 periodically executes the control routine shown in FIG. 4 at predetermined time intervals, thereby enabling for example the control shown by a time chart in FIG. 5.

In FIG. 5, during a period from time T1 to time T2, although the booster internal pressure bpm is larger than the target booster internal pressure BPM, a vehicle is being accelerated. At that time, the electric vacuum pump 18 is being stopped. That is, as shown in FIG. 5, an operation flag of the electric vacuum pump 18 is “0” for a period between the time T1 and the time T2. This can reliably reduce the frequency and the time of operating the electric vacuum pump 18.

As an alternative, the ECU 24 may be configured to determine whether or not the vehicle is being accelerated by use of change amount in engine rotation number, throttle opening degree, vehicle speed, or others, instead of using the accelerator opening degree pa.

In the present example as explained above, even when the booster internal pressure bpm is larger than the target booster internal pressure BPM, the ECU 24 does not operate the electric vacuum pump 18 under the condition that the vehicle mounting the brake system 1 is being accelerated. As above, the electric vacuum pump 18 is not operated during acceleration of the vehicle where a driver is less likely to operate the brake. Accordingly, the frequency of operating the electric vacuum pump 18 and the operating time can be reduced more effectively.

In particular, while the vehicle is being accelerated, the opening degree of the throttle valve 34 is increased, so that the intake-pipe internal pressure pm becomes large and thus the internal pressure of the intake pipe 32 tends to become a low negative pressure. Accordingly, the frequency of operating the electric vacuum pump 18 is likely to be increased. Even at that time, the present example can reduce the frequency of operating the electric vacuum pump 18 more effectively.

### Example 3

Example 3 will be explained below, in which similar or identical parts to those in Examples 1 and 2 are omitted and differences from those are mainly described. In Example 3, even when the booster internal pressure bpm is larger than the target booster internal pressure BPM, the ECU 24 controls the electric vacuum pump 18 not to operate when the intake-pipe internal pressure pm is equal to or lower than the target booster internal pressure BPM. In addition, even when the booster internal pressure bpm is larger than the target booster internal pressure BPM, the ECU 24 controls the electric vacuum pump 18 not to operate during acceleration of a vehicle in which the brake system 1 is mounted.

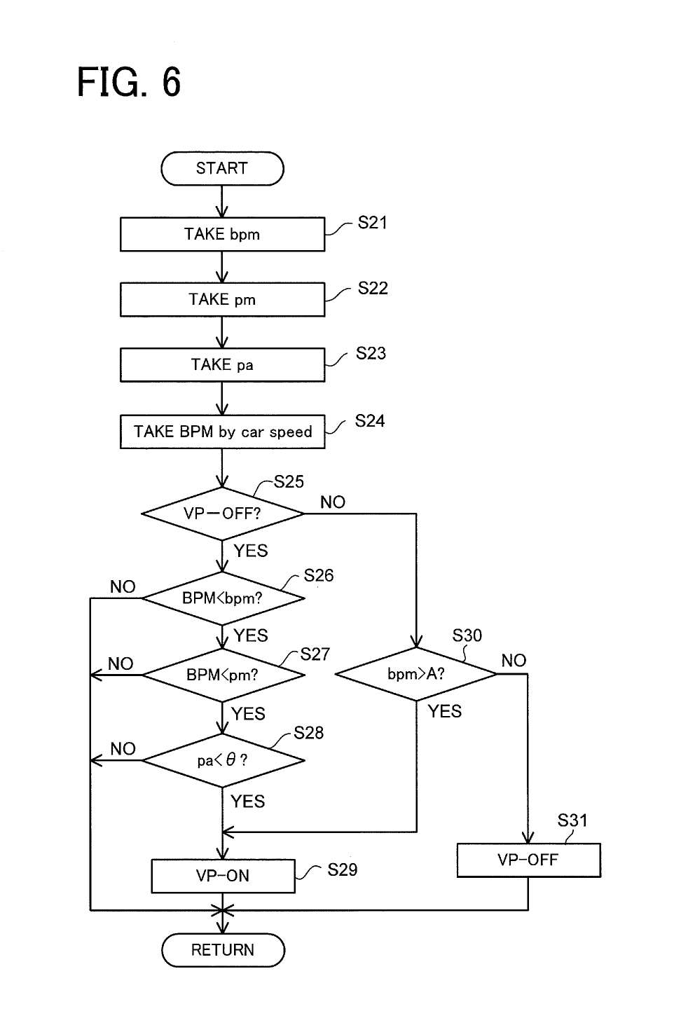

To be concrete, the ECU 24 periodically executes the control routine shown in FIG. 6 at predetermined time intervals.

When the routine processing shown in FIG. 6 is started, the ECU 24 first takes a booster internal pressure bpm, an intake-pipe internal pressure pm, an accelerator opening degree pa, and a target booster internal pressure BPM depending on vehicle speed (steps S21 to S24).

When the electric vacuum pump 18 is being stopped (step S25: YES) and the booster internal pressure bpm is determined to be larger than the target booster internal pressure BPM (step S26: YES), the ECU 24 then determines whether or not the intake-pipe internal pressure pm is larger than the target booster internal pressure BPM (step S27).

When the intake-pipe internal pressure pm is determined to be equal to or lower than the target booster internal pressure BPM (step S27: NO), the ECU 24 temporarily terminates the routine processing while keeping the electric vacuum pump 18 stopped without operating the same.

On the other hand, when the intake-pipe internal pressure pm is determined to be larger than the target booster internal pressure BPM (step S27: YES), the ECU 24 then determines whether or not the accelerator opening degree pa is smaller than the predetermined opening degree θ (step S28).

When the accelerator opening degree pa is determined to be equal to or larger than the predetermined opening degree θ (step S28: NO), the ECU 24 temporarily terminates the routine processing while keeping the electric vacuum pump 18 stopped without operating the same.

The above explanation is related to the control routine shown in FIG. 6.

In the present example, as above, even the booster internal pressure bpm is larger than the target booster internal pressure BPM, the ECU 24 does not operate the electric vacuum pump 18 when the intake-pipe internal pressure pm is equal to or lower than the target booster internal pressure BPM.

At that time, even without operating the electric vacuum pump 18, the booster internal pressure bpm can be decreased to be equal to or lower than the target booster internal pressure BPM by the intake-pipe internal pressure pm. This can reduce the frequency of operating the pump 18 more effectively.

The ECU 24 does not operate the electric vacuum pump 18 under the condition the vehicle mounting the brake system 1 is being accelerated even when the booster internal pressure bpm is larger than the target booster internal pressure BPM. In this way, the electric vacuum pump 18 is not operated during acceleration of the vehicle in which a driver is less likely to operate a brake. Thus, the frequency of operating the pump 18 and the operating time can be reduced more effectively.

### Example 4

Example 4 will be explained below, in which similar or identical parts to those in Examples 1 to 3 are omitted and differences therefrom will be mainly described. In Example 4, even during the vehicle is being accelerated, the ECU 24 controls the electric vacuum pump 18 to operate when a pressure difference Apm obtained by subtracting a target booster internal pressure BPM from a booster internal pressure bpm is larger than a predetermined pressure C.

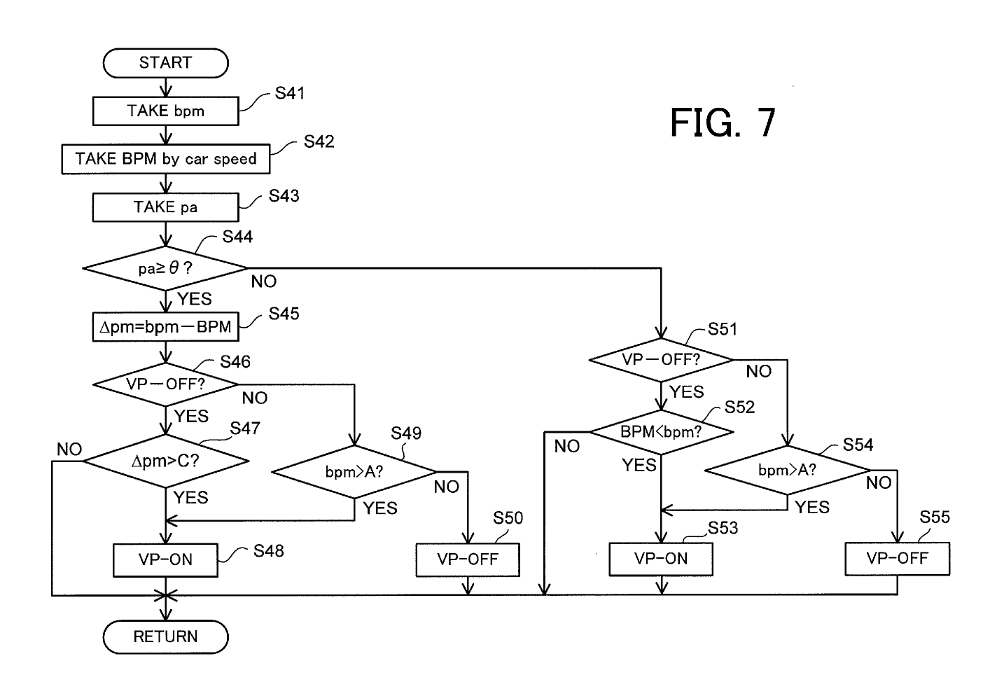

To be concrete, the ECU 24 periodically executes the control routine shown in FIG. 7 at predetermined time intervals.

When the routine processing shown in FIG. 7 is started, the ECU 24 first takes a booster internal pressure bpm, a target booster internal pressure BPM depending on vehicle speed, and an accelerator opening degree pa (steps S41 to S43).

When the accelerator opening degree pa is equal to or larger than the predetermined opening degree θ (step S44: YES), the ECU 24 calculates the pressure difference Δpm by the following expression (step S45):

Δpm=bpm−BPM (Exp. 1)

When the electric vacuum pump 18 is being stopped (step S46: YES), the ECU 24 then determines whether or not the pressure difference Δpm is larger than the predetermined pressure C (step S47). The predetermined pressure C is one example of a “first predetermined pressure” of the invention. The predetermined pressure C is for example 5 kPa.

When the pressure difference Apm is larger than the predetermined pressure C (step S47: YES), the ECU 24 operates the electric vacuum pump 18 (step S48).

As above, even during acceleration of the vehicle in which an accelerator pedal is depressed by a driver with purpose, the ECU 24 operates the electric vacuum pump 18 when the pressure difference Δpm is larger than the predetermined pressure C.

On the other hand, when the pressure difference Δpm is determined to be equal to or lower than the predetermined pressure C (step S47: NO), the ECU 24 keeps the electric vacuum pump 18 stopped and temporarily terminates the routine processing.

When the ECU 24 determines in step S44 that the accelerator opening degree pa is smaller than the predetermined opening degree θ (step S44: NO) and in step S51 that the electric vacuum pump 18 is being stopped (step S51: YES), the ECU 24 further determines whether or not the booster internal pressure bpm is larger than the target booster internal pressure BPM (step S52).

When the booster internal pressure bpm is determined to be larger than the target booster internal pressure BPM (step S52: YES), the ECU 24 operates the electric vacuum pump 18 (step S53) and temporarily terminates the routine processing.

On the other hand, when the booster internal pressure bpm is determined to be equal to or lower than the target booster internal pressure BPM (step S52: NO), the ECU 24 keeps the electric vacuum pump 18 stopped and temporarily terminates the routine processing.

When the ECU 24 judges in step S44 that the accelerator opening degree pa is smaller than the predetermined opening degree θ (step S44: NO) and in step S51 that the electric vacuum pump 18 is being operated (step S51: NO), the ECU 24 determines whether or not the booster internal pressure bpm is larger than the predetermined pressure A (step S54).

When the booster internal pressure bpm is determined to be larger than the predetermined pressure A (step S54: YES), the ECU 24 continues to operate the electric vacuum pump 18 (step S53) and temporarily terminates the routine processing.

On the other hand, when the booster internal pressure bpm is determined to be equal to or lower than the predetermined pressure A (step S54: NO), the ECU 24 stops the electric vacuum pump 18 (step S55) and temporarily terminates the routine processing.

The above explanation is related to the control routine shown in FIG. 7.

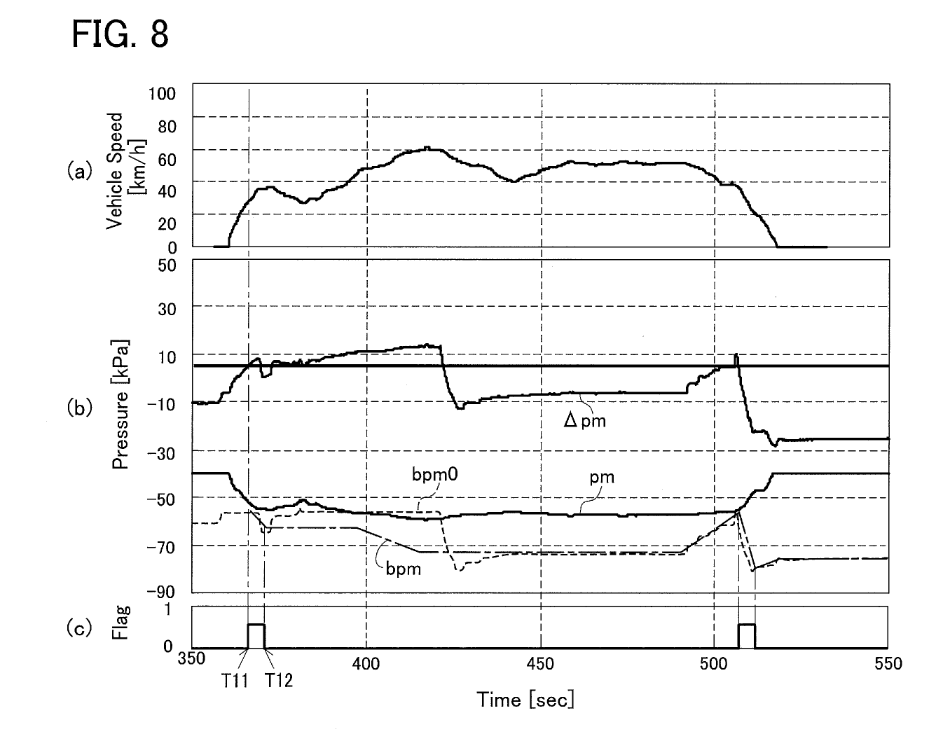

The brake system 1 periodically executes the control routine shown in FIG. 7 at predetermined time intervals, thereby enabling for example the control shown by a time chart in FIG. 8.

In FIG. 8, during a period from time T11 to time T12, the vehicle is being accelerated but the pressure difference Δpm is larger than the predetermined pressure C (e.g., 5 kPa). At that time, the electric vacuum pump 18 is being operated. Specifically, as shown in FIG. 8, during the period from time T11 to time T12, an operation flag of the pump 18 is “1”. Accordingly, the booster internal pressure bpm is smaller than a booster internal pressure bpm0 obtained when the control routine shown in FIG. 7 is not executed, and the booster internal pressure bpm is smaller than the target booster internal pressure BPM.

In the present example, as above, when the pressure difference Δpm obtained by subtracting the target booster internal pressure BPM from the booster internal pressure bpm is larger than the predetermined pressure C, the ECU 24 operates the electric vacuum pump 18 even during acceleration of the vehicle. In a case where the booster internal pressure bpm may largely rises, e.g., when the vehicle is repeatedly accelerated or the vehicle is suddenly stopped from a high-running condition, the ECU 24 operates the electric vacuum pump 18. Therefore, the booster internal pressure bpm is always maintained to be equal to or lower than the target booster internal pressure BPM.

### Example 5

Example 5 will be explained below, in which similar or identical parts to those in Examples 1 to 4 are omitted and differences therefrom will be mainly described. In Example 5, the ECU 24 controls the electric vacuum pump 18 under a different condition to stop the pump 18 under operation from that in Example 4.

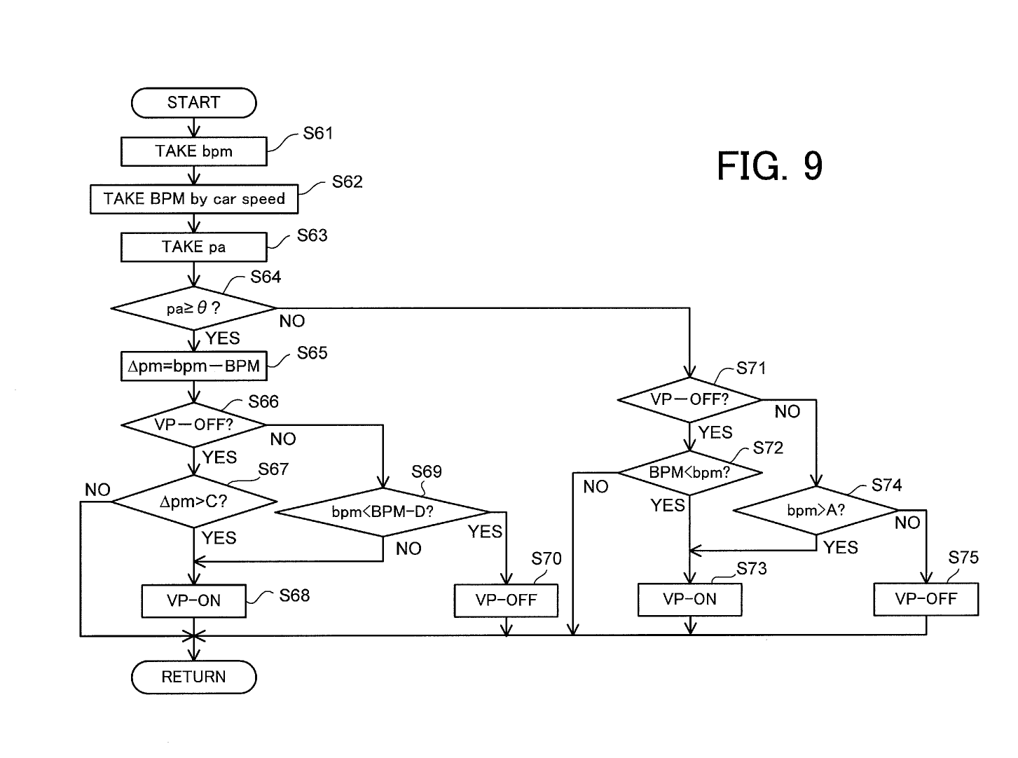

Specifically, the ECU 24 periodically executes the control routine shown in FIG. 9 at predetermined time intervals.

In the routine processing shown in FIG. 9, when it is determined that the accelerator opening degree pa is equal to or larger than the predetermined opening degree θ (step S64: YES) and the electric vacuum pump 18 is being operated (step S66: NO), the ECU 24 determines whether or not the following conditional expression is satisfied (step S69):

bpm<(BPM−D) (Exp. 2)

A predetermined pressure D is one example of a “second predetermined pressure” of the invention. This predetermined pressure D is for example 10 kPa.

When it is determined the conditional expression Exp. 2 is satisfied (step S69: YES), the ECU 24 stops the electric vacuum pump 18 (step S70) and temporarily terminates the routine processing.

During acceleration of the vehicle and during operation of the electric vacuum pump 18, the ECU 24 stops the electric vacuum pump 18 when the conditional expression Exp. 2 is satisfied.

On the other hand, when it is determined that conditional expression Exp. 2 is not satisfied (step S69: NO), the ECU 24 continues to operate the electric vacuum pump 18 (step S68) and temporarily terminates the routine processing.

The above explanation is related to the control routine shown in FIG. 9.

In the present example explained above, the ECU 24 stops the electric vacuum pump 18 when the conditional expression “bpm<(BPM−D)” is met while the vehicle is being accelerated and the pump 18 is being operated. In this way, during acceleration of the vehicle and during operation of the pump 18, when the booster internal pressure bpm decreases below the target booster internal pressure BPM by an amount corresponding to the predetermined pressure D, the ECU 24 stops the pump 18. Accordingly, the frequency of operating the electric vacuum pump 18 can be reduced as compared with a control method to operate the pump 18 until the booster internal pressure bpm decreases below a pump stop pressure set to an always fixed value.

### Example 6

Example 6 will be explained below, in which similar or identical parts to those in Examples 1 to 5 are omitted and differences therefrom will be mainly described. In Example 6, the ECU 24 controls the electric vacuum pump 18 under a different condition to stop the pump 18 under operation from those in Examples 4 and 5.

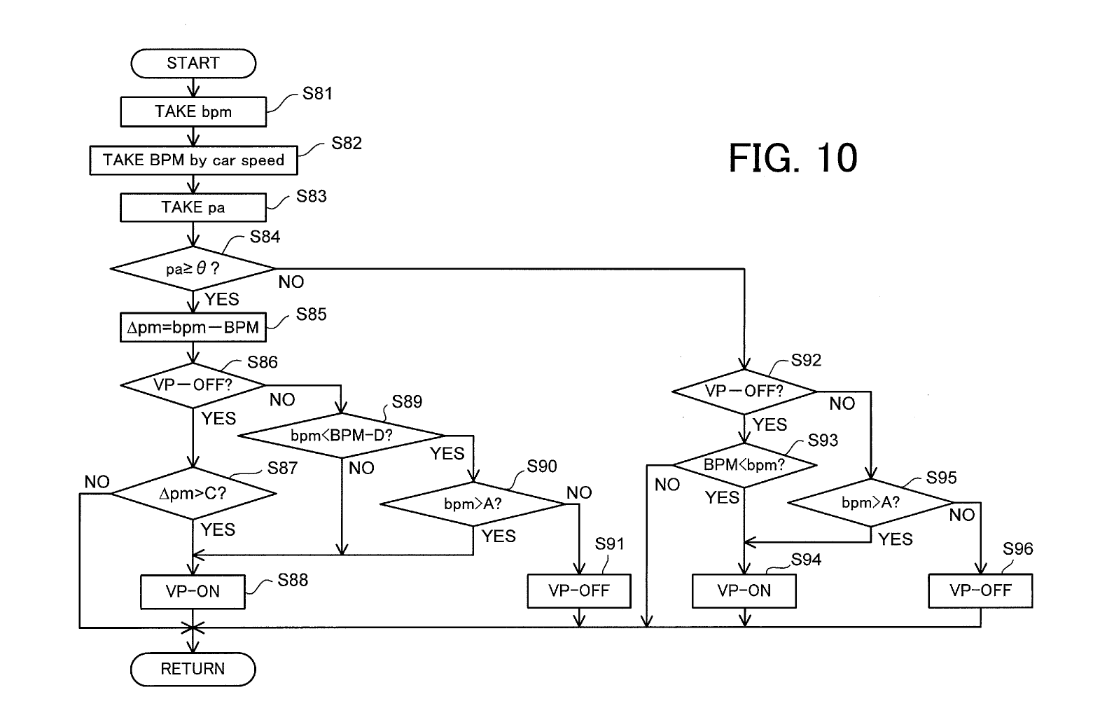

To be specific, the ECU 24 periodically executes the control routine shown in FIG. 10 at predetermined time intervals.

In the routine processing shown in FIG. 10, when it is determined that the accelerator opening degree pa is equal to or larger than the predetermined opening degree θ (step S84: YES), the electric vacuum pump 18 is being operated (step S86: NO), and when the booster internal pressure bpm is smaller than a pressure (a calculated value) obtained by subtracting the predetermined pressure D from the target booster internal pressure BPM (step S89: YES), the ECU 24 then determines whether or not the booster internal pressure bpm is larger than the predetermined pressure A (step S90).

When the booster internal pressure bpm is determined to be equal to or lower than the predetermined pressure A (step S90: NO), the ECU 24 stops the electric vacuum pump 18 and temporarily terminates the routine processing. On the other hand, when the booster internal pressure bpm is determined to be larger than the predetermined pressure A (step S90: YES), the ECU 24 continues to operate the electric vacuum pump 18 and temporarily terminates the routine processing.

### Example 7

Example 7 will be explained below, in which similar or identical parts to those in Examples 1 to 6 are omitted and differences therefrom will be mainly described.

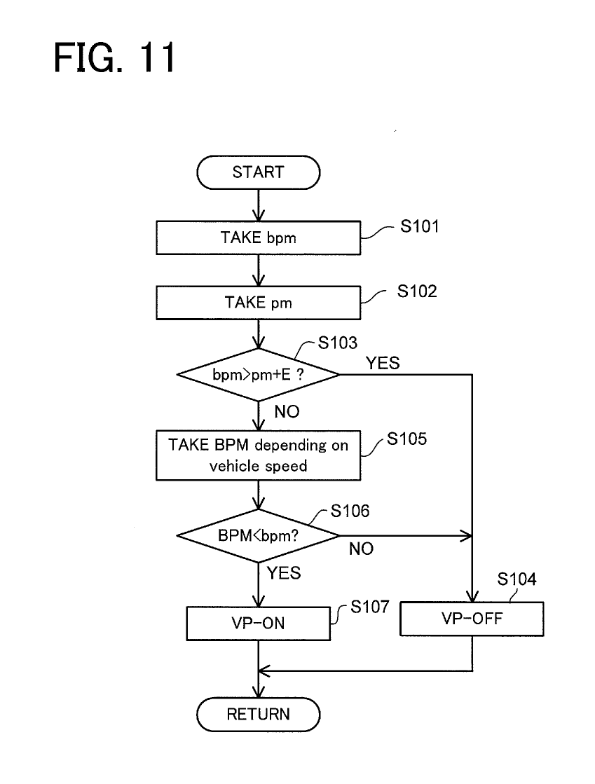

To be specific, the ECU 24 periodically executes the control routine shown in FIG. 11 at predetermined time intervals.

When the routine processing shown in FIG. 11 is started, the ECU 24 first takes a booster internal pressure bpm and an intake-pipe internal pressure pm (step S101 and step S102).

The ECU 24 then determines whether or not the booster internal pressure bpm is larger than a pressure (a calculated value) obtained by adding a predetermined pressure E to the intake-pipe internal pressure pm (step S103). The predetermined pressure E is for example 5 kPa.

When the booster internal pressure bpm is determined to be larger than the pressure calculated by adding the predetermined pressure E to the intake-pipe internal pressure pm (step S103: YES), the ECU 24 stops the electric vacuum pump 18 (step S104) and temporarily terminates the routine processing. Specifically, when the intake-pipe internal pressure pm is smaller than the booster internal pressure bpm, the ECU 24 does not operate the electric vacuum pump 18. At that time, the booster internal pressure bpm is reduced by the intake-pipe internal pressure pm. That is, the negative pressure in the intake pipe 32 is supplied into the negative pressure chamber of the brake booster 12.

When the booster internal pressure bpm is approximate to the intake-pipe internal pressure pm, the booster internal pressure bpm decreases a little slowly. As mentioned above, accordingly, when the booster internal pressure bpm is determined to be larger than the pressure calculated by adding the predetermined pressure E to the intake-pipe internal pressure pm (step S103: YES), the ECU 24 stops the electric vacuum pump 18.

On the other hand, when the booster internal pressure bpm is determined to be equal to or lower than the pressure calculated by adding the predetermined pressure E to the intake-pipe internal pressure pm (step S103: NO), the ECU 24 takes the target booster internal pressure BPM depending on vehicle speed (step S105).

The ECU 24 then determines whether or not the booster internal pressure bpm is larger than the target booster internal pressure BPM (step S106).

When the booster internal pressure bpm is determined to be larger than the target booster internal pressure BPM (step S106: YES), the ECU 24 activates the electric vacuum pump 18 (step S107) and temporarily terminates the routine processing.

On the other hand, when the booster internal pressure bpm is determined to be equal to or lower than the target booster internal pressure BPM (step S106: NO), the ECU 24 stops the electric vacuum pump 18 (step S104) and temporarily terminates the routine processing.

The above explanation shown in FIG. 11 is related to the control routine.

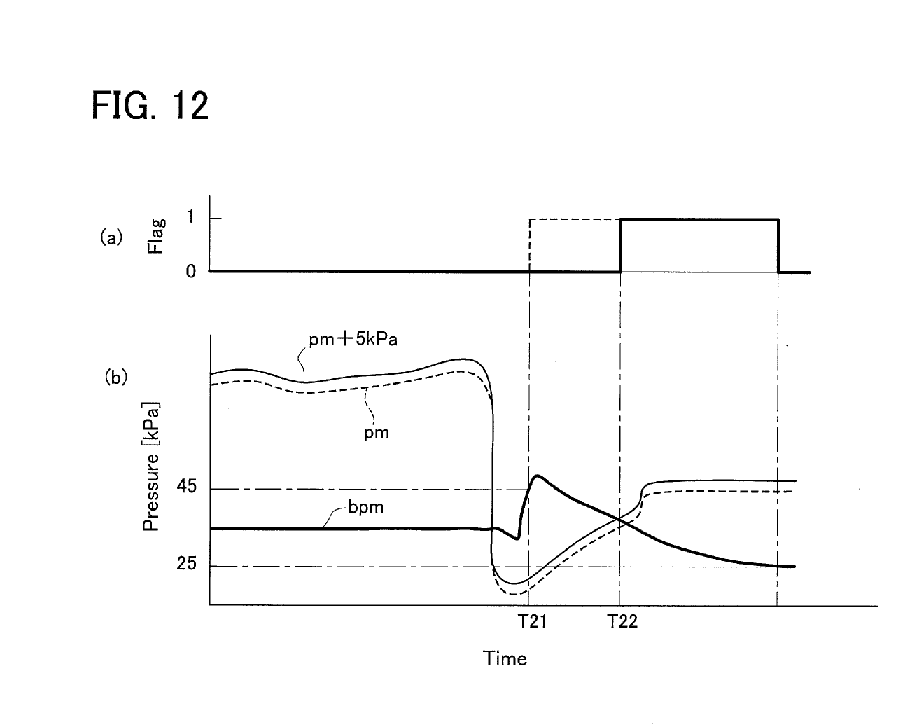

In the brake system 1, the ECU 24 periodically executes the control routine shown in FIG. 11 at predetermined time intervals, thereby enabling for example the control shown by a time chart in FIG. 12. Herein, a comparative example is conceived in which the electric vacuum pump 18 is started to operate when the booster internal pressure bpm exceeds 45 kPa, but the pump 18 is stopped when the booster internal pressure bpm decreases below 25 kPa. FIG. 12 (a) shows a behavior of an operation flag of the electric vacuum pump 18. In FIG. 12 (a), the present example is indicated by a solid line and the comparative example is indicated by a broken line.

As shown in FIG. 12, at the time when the booster internal pressure bpm exceeds 45 kPa at time T21, the electric vacuum pump 18 in the comparative example (the broken line in FIG. 12 (a)) is started to operate, or turned on. In contrast, the electric vacuum pump 18 of the present example (the solid line in FIG. 12 (a)) is held stopped because the booster internal pressure bpm is larger than the pressure calculated by adding 5 kPa to the intake-pipe internal pressure pm as shown in FIG. 12 (b).

As show in FIG. 12, at subsequent time T22, when the booster internal pressure bpm becomes smaller than the pressure calculated by adding 5 kPa to the intake-pipe internal pressure pm, the electric vacuum pump 18 of the present example is started to operate, or turned on.

As shown in FIG. 12, accordingly, the operating time of the electric vacuum pump 18 of the present example is reduced than the comparative example by an amount of time defined between time T21 and time T22.

In the present example, as above, even when the booster internal pressure bpm is larger than the target booster internal pressure BPM, the ECU 24 does not operate the electric vacuum pump 18 under the condition that the intake-pipe internal pressure pm is smaller than the booster internal pressure bpm. In a case where the booster internal pressure bpm can be reduced by a pressure difference between the intake-pipe internal pressure pm and the booster internal pressure bpm as explained above, the electric vacuum pump 18 is not operated. Accordingly, the frequency and time of operating the electric vacuum pump 18 can be reduced more effectively. In particular, while a brake pedal is depressed by a driver, the opening degree of the throttle valve 34 is decreased, so that the intake-pipe internal pressure pm becomes small and thus the performance of reducing the booster internal pressure bpm can be enhanced.

### Example 8

Example 8 will be explained below, in which similar or identical parts to those in Examples 1 to 7 are omitted and differences therefrom will be mainly described.

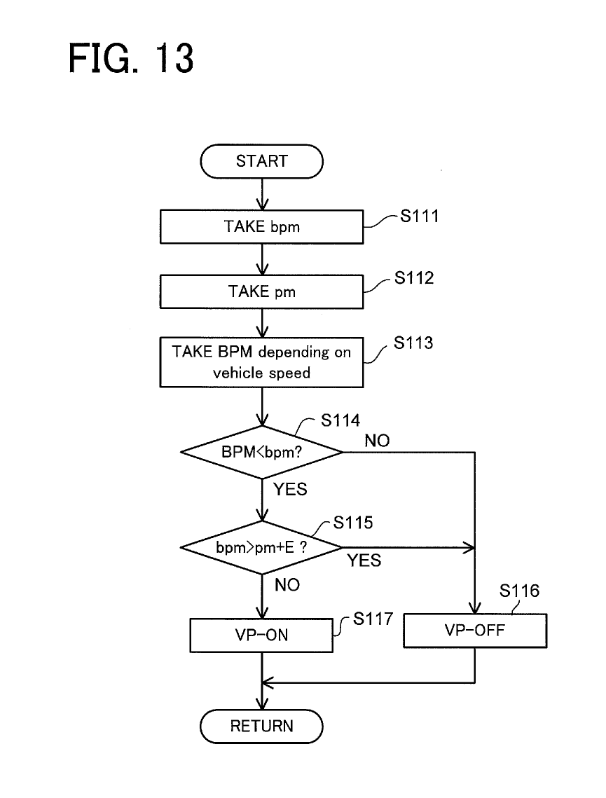

To be specific, the ECU 24 periodically executes the control routine shown in FIG. 13 at predetermined time intervals.

When the routine processing shown in FIG. 13 is started, the ECU 24 first takes a booster internal pressure bpm, an intake-pipe internal pressure pm, and a target booster internal pressure BPM depending on vehicle speed (steps S111 to S113).

It is then determined whether or not the booster internal pressure bpm is larger than the target booster internal pressure BPM (step S114).

When the booster internal pressure bpm is determined to be larger than the target booster internal pressure BPM (step S114: YES), the ECU 24 further determines whether or not the booster internal pressure bpm is larger than a pressure (a pressure value) calculated by adding the predetermined pressure E to the intake-pipe internal pressure pm (step S115).

When the booster internal pressure bpm is determined to be larger than the pressure obtained by adding the predetermined pressure E to the intake-pipe internal pressure pm (step S115: YES), the ECU 24 stops the electric vacuum pump 18 (step S116) and temporarily terminates the routine processing. Specifically, when the intake-pipe internal pressure pm is smaller than the booster internal pressure bpm, the ECU 24 does not operate the electric vacuum pump 18. At that time, the booster internal pressure bpm is decreased by the intake-pipe internal pressure pm. Specifically, the negative pressure in the intake pipe 32 is supplied to the negative pressure chamber of the brake booster 12.

In contrast, when the booster internal pressure bpm is determined to be equal to or lower than the pressure calculated by addition of the predetermined pressure E to the intake-pipe internal pressure pm (step S115: NO), the ECU 24 operates the electric vacuum pump 18 (step S117) and temporarily terminates the routine processing.

When the booster internal pressure bpm is determined to be equal to or lower than the target booster internal pressure BPM (S114: NO), the ECU 24 stops the electric vacuum pump 18 (step S116) and temporarily terminates the routine processing.

In the present example, as above, even when the booster internal pressure bpm is larger than the target booster internal pressure BPM, the ECU 24 does not operate the electric vacuum pump 18 under the condition that the intake-pipe internal pressure pm is smaller than the booster internal pressure bpm. In this way, when the booster internal pressure bpm can be reduced by the pressure difference between the intake-pipe internal pressure pm and the booster internal pressure bpm, the electric vacuum pump 18 is not operated. This can more effectively reduce the frequency and time of operating the electric vacuum pump 18.

The above embodiments are mere examples and do not limit the invention. The present invention may be embodied in other specific forms without departing from the essential characteristics thereof.

Reference Signs List

| 1 | Brake System | 12 | Brake booster |
|---|---|---|---|
| 16 | Pressure sensor | 18 | Electric vacuum pump |
| 18a | Inlet | 24 | ECU |
| 26 | Intake-pipe internal-pressure detection unit | | |
| 32 | Intake pipe | 34 | Throttle valve |
| bpm | Booster internal pressure | BPM | Target booster internal pressure |
| pm | Intake-pipe internal pressure | pa | Accelerator opening degree |
| Δpm | Pressure difference | A | Predetermined pressure |
| C | Predetermined pressure | D | Predetermined pressure |
| E | Predetermined pressure | θ | Predetermined opening degree |

1. A method of controlling a brake system of an engine, the brake system including a brake booster having a negative pressure chamber and a vacuum pump having an inlet connected to the negative pressure chamber, the engine having an intake system being connected to the negative pressure chamber,
wherein the method includes a basic control to operate the vacuum pump when a booster internal pressure which is an actual pressure in the negative pressure chamber is larger than a target booster internal pressure which is a target pressure in the negative pressure chamber, and
the vacuum pump is not operated under a predetermined condition even when the booster internal pressure is larger than the target booster internal pressure.

2. The method of controlling a brake system according to claim 1,
wherein the predetermined condition includes a condition that an internal pressure of the intake system is equal to or lower than the target booster internal pressure.

3. The method of controlling a brake system according to claim 1,
wherein the predetermined condition includes a condition that a vehicle in which the brake system is mounted is being accelerated.

4. The method of controlling a brake system according to claim 3,
wherein the vacuum pump is operated when a pressure difference calculated by subtracting the target booster internal pressure from the booster internal pressure is larger than a first predetermined pressure even during acceleration of the vehicle.

5. The method of controlling a brake system according to claim 4,
wherein when the booster internal pressure is bpm, the target booster internal pressure is BPM, and a second predetermined pressure is D,
the vacuum pump is stopped when a conditional expression of bpm<(BPM−D) is met while the vehicle is being accelerated and the vacuum pump is being operated.

6. The method of controlling a brake system according to claim 1,
wherein the predetermined condition includes a condition that the internal pressure of the intake system is smaller than the booster internal pressure.
